(19) United States
(12) Patent Application Publication
(10) Pub. No.: US 2008/0253309 A1
(43) Pub. Date: Oct. 16, 2008

(54) WIRELESS NODE AND INSTALLATION METHOD FOR WIRELESS INFRASTRUCTURE

(75) Inventor: Charles R. Obranovich, Blaine, MN (US)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL INC., Morristown, NJ (US)

(21) Appl. No.: 11/735,702

(22) Filed: Apr. 16, 2007

(51) Int. Cl. H04B 7/00

(52) U.S. Cl. 370/310

(57) ABSTRACT

A node for a wireless communication infrastructure is provided. The node comprises a transceiver, a routing circuit, a power supply and switch. The transceiver is configured to transmit and receive wireless communication signals. The routing circuit is configured to route signals to and from other nodes and data sinks via the transceiver. The power supply is configured to supply power to the transceiver and the routing circuit. Finally, the switch is configured to toggle routing functions of the routing circuit on and off.

### GOVERNMENT LICENSE RIGHTS

The U.S. Government may have certain rights in the present invention as provided for by the terms of Government Contract # DAAE07-03-9-F001 awarded by the Army.

### BACKGROUND

Wireless communication networks typically include a base station and a plurality of nodes positioned throughout the area in which the wireless communication network is to reach. The nodes typically provide two functions in relation to communications with the base station. The first is to communicate with the base station when within a direct communication range and the second is to route communication signal to the base station from other nodes that are outside the direct communication range of the base station. Installing wireless infrastructure that forms a typical wireless communication network as described typically takes a fair amount of time. Detailed knowledge of the area to be covered and as well as range limits of the base station and nodes must be known. Moreover, nodes as currently made perform routing functions right out of the box. Hence, the nodes are routing for other nodes even before they are positioned which wastes a lot of energy.

For the reasons stated above and for other reasons stated below which will become apparent to those skilled in the art upon reading and understanding the present specification, there is a need in the art for an effective node and an efficient method of installing a wireless infrastructure.

### SUMMARY OF INVENTION

The above-mentioned problems of current systems are addressed by embodiments of the present invention and will be understood by reading and studying the following specification. The following summary is made by way of example and not by way of limitation. It is merely provided to aid the reader in understanding some of the aspects of the invention.

In one embodiment, a node for a wireless communication infrastructure is provided. The node comprises a transceiver, a routing circuit, a power supply and switch. The transceiver is configured to transmit and receive wireless communication signals. The routing circuit is configured to route signals to and from other nodes and data sinks via the transceiver. The power supply is configured to supply power to the transceiver and the routing circuit. Finally, the switch is configured to toggle routing functions of the routing circuit on and off.

### BRIEF DESCRIPTION OF THE DRAWINGS

The present invention can be more easily understood and further advantages and uses thereof more readily apparent, when considered in view of the detailed description and the following figures in which:

FIG. 1 is an illustration of the formation of a wireless infrastructure of one embodiment of the present invention;

FIG. 2 is a block diagram of a communication node of one embodiment of the present invention; and

FIG. 3 is a formation flow diagram of a formation of a wireless infrastructure of one embodiment of the present invention.

In accordance with common practice, the various described features are not drawn to scale but are drawn to emphasize specific features relevant to the present invention. Reference characters denote like elements throughout Figures and text.

### DETAILED DESCRIPTION

In the following detailed description, reference is made to the accompanying drawings, which form a part hereof, and in which is shown by way of illustration specific embodiments in which the inventions may be practiced. These embodiments are described in sufficient detail to enable those skilled in the art to practice the invention, and it is to be understood that other embodiments may be utilized and that logical, mechanical and electrical changes may be made without departing from the spirit and scope of the present invention. The following detailed description is, therefore, not to be taken in a limiting sense, and the scope of the present invention is defined only by the claims and equivalents thereof.

Embodiments of the present invention provide a method of setting up a wireless infrastructure that includes nodes with two different states. The first state or setup state is used before the nodes are positioned within an area to be covered by wireless network. In the setup state, functions relating to routing are turn off to conserve energy. In the second state or active state, the node functions relating to routing are turned on. A node is placed in the second state when it is positioned in a desired location to create the wireless infrastructure. In some embodiments, an indicator is used that indicates when a node is within range of a data sink either directly or via the routing of another node. In still other embodiments, an indicator is used to confirm the state of the node.

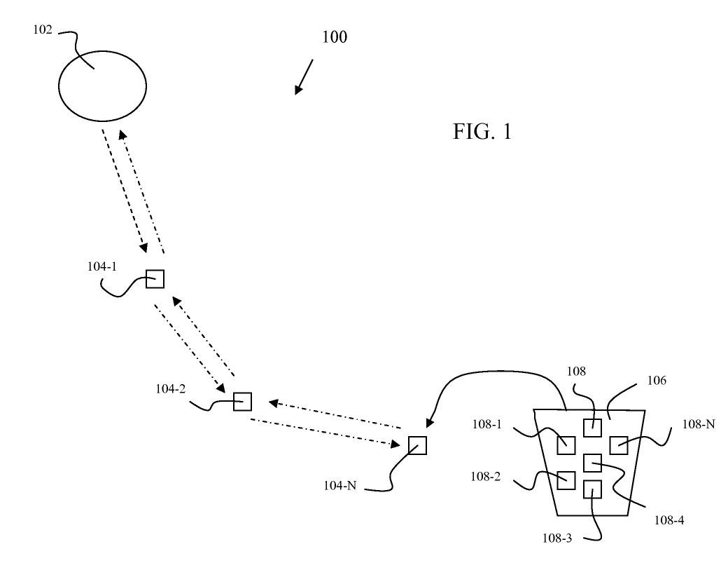

Referring to FIG. 1 an illustration of the formation of a wireless infrastructure 100 that forms a wireless network of one embodiment is illustrated. The wireless infrastructure 100 includes a base station 102 (or data sink 102) and a plurality of nodes 104-2 through 104-N and 108-1 through 108-N. The data sink 102 provides a link to the outside world for each placed node 104. Devices within the wireless communication network can then communicate with the placed nodes 104. Nodes 104-1 through 104-N represent nodes 104 that have been switched into the second active state. This occurs when they are placed in the select location within the wireless infrastructure 100. Nodes 108-1 through 108-N represent nodes 108 that are in the first state (the setup state). The routing functions in these nodes 108 are turn off. As discussed above, in embodiments of the present invention, the nodes are switched from the setup state to the active state when they are set in a select location within the wireless infrastructure 100. In FIG. 1, nodes 108 are transported in a container 106 prior to their placement.

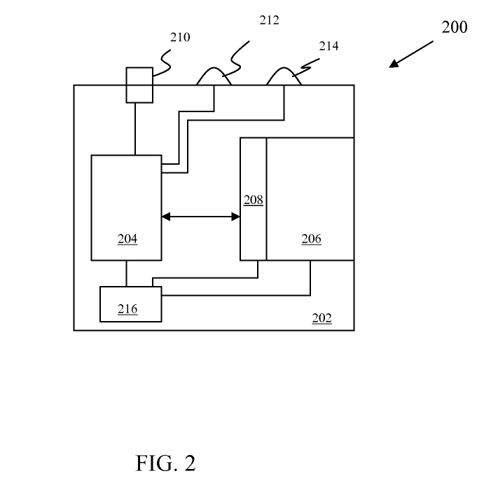

FIG. 2 is a block diagram of a communication node 200 of one embodiment. In this embodiment, node 200 includes a controller 204, routing circuit 208, transceiver 206 switch 210, a power source 216 and a within range indicator 212. The controller 204 controls function of the node 200 including the receiving and transmission of communication signals through the transceiver 206. The routing circuit 208 includes routing functions that allow the node 200 to route communication signals between other nodes and at least one data sink. Switch 210 is used to select the state of the node 200. In this embodiment, the controller 204 is in communication with the switch 210 and actives and de-actives routing function of the routing circuit 208 based on the manipulation of the switch 210. The within range indicator 212 (or range indicator) indicates when the node is within range (can exchange communications) of a data sink or another node. In one embodiment, the range indicator 212 is a light such as a light emitting diode (LED). Other types of indicators such as, but not limited to, lights, sounds, vibrations are contemplated. In one embodiment, the controller 204 activates the range indicator 212 based on received signals by the transceiver 206 from another node or a data sink. Further in one embodiment, a state indicator 214 is included. The state indicator 214 indicates the state of node 200. Hence, the user is able to tell whether the node 200 is in the setup state or the activation state. In one embodiment, the within state indicator 214 is a light such as a light emitting diode (LED). Other types of indicators such, as but not limited to, lights, sounds, vibrations are contemplated. In one embodiment, the controller 204 controls the state indicator 212 based on an activation or manipulation of the switch. The power source 216 is used to power the devices of the node 200 including the controller 204, the router function 208, the transceiver 206 and the indicators 212 and 214.

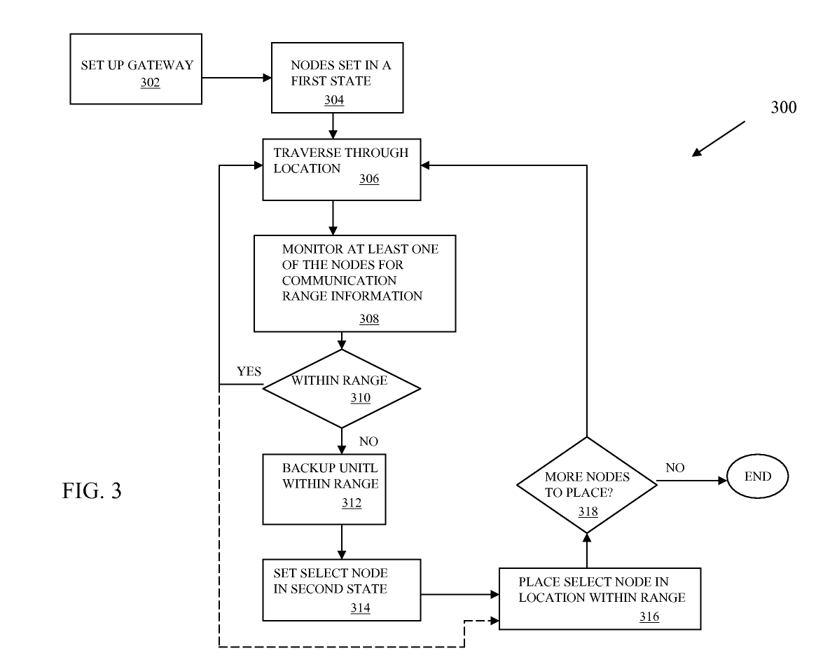

FIG. 3 is a formation flow diagram 300 illustrating a formation of a wireless infrastructure of one embodiment. As illustrated this method starts by setting up a data sink (302). It will be understood that the data sink could already be set up and the expansion of the infrastructure is desired by the addition of nodes. The nodes are set in the first state (setup state) (304). This can be done by the manufacture of the nodes at the time they are made or when the power source is connected. The user (or technician) then traverses through the area where the wireless network is to be set up with a container of nodes in the setup state (306). The technician monitors the within range indicator of at least one of the nodes for range information (308). As long as the monitored within range indicator indicates that the respective node is within the communication range of a data sink or other node (310), the technician continues to traverse through the area (306). Once the monitored within range indicator indicates that it is no longer within the communication range of the data sink or another node (310), the technician stops and backs up until the monitored within range indicator indicates that the respective node is once again within the communication range of the data sink or other node (312). A node is then placed in the second state (or active state) (314). This allows the node to route communication signals from other nodes. The node that has been switched to the active state is then placed in a location within the range (316).

In some embodiments, a placed node does not need to be placed at the edge of the then current network's communication range. Instead, the range indicator of a node is just used to verify that a desired location placement is within the communication range of the network. This alternative method is also illustrated in FIG. 3. As illustrated in FIG. 3, it is determined if the node is within the communication range (310). If it is within the communication range (310), the node is placed in the select location (316). It is then determined if more nodes are to be placed (318). If no other nodes are to be placed (318), the process ends. However, if more nodes are to be placed (318), the process continues at (306).

Generally, the methods and techniques used by the controller and routing functions in embodiments of the present invention may be implemented in digital electronic circuitry, or with a programmable processor (for example, a special-purpose processor or a general-purpose processor such as a computer) firmware, software, or in combinations of them generally defined as modules. Apparatus embodying these techniques may include appropriate input and output devices, a programmable processor, and a storage medium tangibly embodying program instructions for execution by the programmable processor. A process embodying these techniques may be performed by a programmable processor executing a program of instructions to perform desired functions by operating on input data and generating appropriate output. The techniques may advantageously be implemented in one or more programs that are executable on a programmable system including at least one programmable processor coupled to receive data and instructions from, and to transmit data and instructions to, a data storage system, at least one input device, and at least one output device. Generally, a processor will receive instructions and data from a read-only memory and/or a random access memory. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and DVD disks. Any of the foregoing may be supplemented by, or incorporated in, specially-designed application-specific integrated circuits (ASICs).

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

1. A node for a wireless communication infrastructure, the node comprising:
a transceiver to transmit and receive wireless communication signals;
a routing circuit configured to route signals to and from other nodes and data sinks via the transceiver;
a power supply configured to supply power to the transceiver and the routing circuit; and
a switch configured to toggle routing functions of the routing circuit on and off.

2. The node of claim 1, further comprising:
a controller configured to toggle the routing functions of the routing circuit based on an activation of the switch.

3. The node of claim 1, further comprising:
a state indicator configured to indicate the state of the routing functions.

4. The node of claim 3, wherein the state indicator is a light emitting diode powered by the power supply.

5. The node of claim 3, wherein the state of the routing functions is one of a setup state and an active state.

6. The node of claim 3, further comprising:
a controller coupled to the switch, the controller further configured to control the state indicator based on a manipulation of the switch.

7. The node of claim 1, further comprising:
a range indicator configured to indicate when the node is within the communication range of at least one of another node and data sink.

8. The node of claim 7, wherein the range indicator is a light emitting diode powered by the power supply.

9. The node of claim 7, further comprising:
a controller coupled to the transceiver and the range indicator, the controller configured to activate the range indicator based on received communication signals by the transceiver.

10. A wireless communication infrastructure, the infrastructure comprising:
at least one data sink; and
a plurality of nodes, at least one node including:
a transceiver to transmit and receive wireless communication signals,
a routing circuit configured to route signals to and from other nodes and data sinks via the transceiver,
a switch configured to toggle routing functions of the routing circuit on and off,
a controller configured to control the transceiver and routing circuit, and
a power supply configured to supply power to the controller, the transceiver and the routing circuit.

11. The infrastructure of claim 10, wherein the at least one node further comprises:
a state indicator configured to indicate the state of the routing functions.

12. The infrastructure of claim 11, wherein the state indicator is a light emitting diode powered by the power supply.

13. The infrastructure of claim 10, wherein the at least one node further comprises
a range indicator configured to indicate when the node is within the communication range of at least one of another node and data sink.

14. The infrastructure of claim 13, wherein the range indicator is a light emitting diode powered by the power supply.

15. A method of forming a wireless infrastructure, the method comprising:
placing a plurality of nodes that are each in a setup state that disables routing functions in select locations to form the wireless infrastructure; and
setting each placed node in an activation state that enables routing functions once placed in the select locations.

16. The method of claim 15, further comprising:
initially setting each of the plurality of nodes in the setup state.

17. The method of claim 15, further comprising:
traversing through an area the wireless infrastructure is to be formed;
monitoring a range indicator on at least one of the plurality of nodes; and
placing nodes in select locations based on the range indicator.

18. The method of claim 17, wherein placing nodes in select locations based on the range indicator further comprises:
traversing until the monitored range indicator indicates the node is beyond the range of communications with at least one of another nodes and a data sink; and
backing up until the monitored range indicator indicates the node is once again within the range of communications with the at least one the other node and the data sink.

19. The method of claim 15, further comprising:
initially setting up a data sink to communicate with the plurality of nodes.

20. The method of claim 15, further comprising:
confirming the state of each node via state indicator.
